(19) United States
(12) Patent Application Publication
(10) Pub. No.: US 2017/0124189 A1
(43) Pub. Date: May 4, 2017

(54) DEVICE AND METHOD FOR STORING CHANNEL DATA

(71) Applicants: Le Holdings (Beijing) Co., Ltd., Beijing (CN); Le Shi Zhi Xin Electronic Technology (Tianjin) Limited, Tianjin (CN)

(72) Inventor: Xianke Liu, Tianjin (CN)

(73) Assignees: Le Holdings (Beijing) Co., Ltd., Beijing (CN); Le Shi Zhi Xin Electronic Technology (Tianjin) Limited, Tianjin (CN)

(21) Appl. No.: 15/239,420

(22) Filed: Aug. 17, 2016

Related U.S. Application Data
(63) Continuation of application No. PCT/CN2016/086612, filed on Jun. 21, 2016.

(30) Foreign Application Priority Data
Nov. 2, 2015 (CN) 201510734185.3

(51) Int. Cl. G06F 17/30; H04N 21/266; H04N 21/278

(52) U.S. Cl. CPC G06F 17/30858; H04N 21/278; H04N 21/266

(57) ABSTRACT

The present disclosure provides a device and a method for storing channel data. The method includes: reading channel list data; serializing the channel list data into a byte stream; and writing the byte stream into a channel data file. In the present disclosure, the channel data can be more conveniently stored through a manner of serializing the channel list data into the byte stream and storing the byte stream into the channel data file, and meanwhile the memory and storage time is saved.

### CROSS-REFERENCE TO RELATED APPLICATIONS

This application is a continuation of International Application No. PCT/CN2016/086612, with an international filing date of filed Jun. 21, 2016, which is based upon and claims priority to Chinese Patent Application No. 201510734185.3, filed on Nov. 2, 2015, the entire contents of all of which are incorporated herein by reference.

### TECHNICAL FIELD

The present disclosure relates to the field of data storage, and more particularly, to a method and a device for storing channel data.

### BACKGROUND

Because there have been more and more live application softwares based on internet contents, smart set-top boxes provide more and more channels, and some may even provide more than 500 channels. Therefore, the storage of channel data is very important.

In the prior art, a manner for storing the channel data includes: 1) acquiring channel list data from a channel server; and 2) storing the channel list data locally in a manner of database, while for the manner of database it needs to store the basic information data of each channel in the channel list data in a basic information table and store video stream data in a video stream table. When the channel list data of the server is changed, the basic information table and the video stream table need to be updated respectively. It needs to construct an object separately for each channel to store the basic information data and the video stream data corresponding to each channel when expecting to read data from the basic information table and the video stream table.

During the process of research and development, the inventor has found that storage of the channel data by using the manner of database makes storage and read of the channel data very tedious, time-consuming and also occupy the memory; moreover, the way of constructing one object separately for each channel will cause multiple small objects in the memory so as to result in memory fragmentation.

Therefore, it is necessary to improve the above-mentioned disadvantages.

### SUMMARY

In order to overcome the problems in the prior art that the storage and read of the channel data by using the manner of database is very tedious, occupies the memory and is time-consuming, the embodiments of the present disclosure provide a method and a device for storing channel data, which are more convenient to store the channel data through a manner of serializing the channel list data into a byte stream and storing the byte stream into a channel data file, and save the memory and storage time in the meanwhile.

In one aspect, one embodiment of the present disclosure provides a method for storing channel data, including: reading channel list data; serializing the channel list data into a byte stream; and writing the byte stream into a channel data file.

Optionally, the channel list data includes basic channel information and a channel video stream, and the basic channel information includes a channel number and a channel name.

Optionally, the channel list data is read from a server storing the channel list data, or the channel list data is read locally.

Optionally, the byte stream of the channel data file is read in response to a channel data file reading instruction, and the byte stream is deserialized such that the channel list data is obtained.

Optionally, the channel list data is serialized into the byte stream using a serialization mechanism provided by a JAVA programming language.

In another aspect, one embodiment of the present disclosure provides a device for storing channel data, including:

at least one processor; and

a memory communicably connected with the at least one processor and for storing instructions executable by the at least one processor,

wherein execution of the instructions by the at least one processor causes the at least one processor to:

read channel list data;

serialize the channel list data into a byte stream; and

write the byte stream into a channel data file.

According to another aspect of the present application, the present application also provides a computer-readable medium, wherein the computer-readable medium is recorded with a computer program configured to execute the method for storing channel data according to the present application.

It could produce the following advantageous effects by employing the foregoing technical solution: the channel data is stored more conveniently through a manner of serializing the channel list data into the byte stream and storing the byte stream into the channel data file, and the memory and storage time are saved in the meanwhile.

### BRIEF DESCRIPTION OF THE DRAWINGS

In order to explain the technical solutions in the detailed embodiments of the present disclosure more clearly, the drawings used in the embodiments will be simply introduced hereinafter. It is apparent that the drawings described hereinafter merely represent some embodiments of the present disclosure, and those skilled in the art may also obtain other drawings according to these drawings without going through creative work.

FIG. 1 is a flow chart of a method for storing channel data according to an embodiment of the present disclosure;

FIG. 2 is a flow chart of a method for storing channel data according to another embodiment of the present disclosure; and

FIG. 3 is a block diagram of a device for storing channel data according to another embodiment of the present disclosure.

### DETAILED DESCRIPTION

The specific embodiments of the present disclosure will be described clearly and completely hereinafter with reference to the accompanying drawings. Apparently, the embodiments described are some, but not all embodiments of the present disclosure. All the other embodiments derived by those skilled in the art on the basis of the embodiments of the present disclosure without going through creative efforts shall all fall within the protection scope of the present disclosure. The technical features involved in different embodiments of the present disclosure described herein may be combined mutually as long as no conflictions are constituted there among.

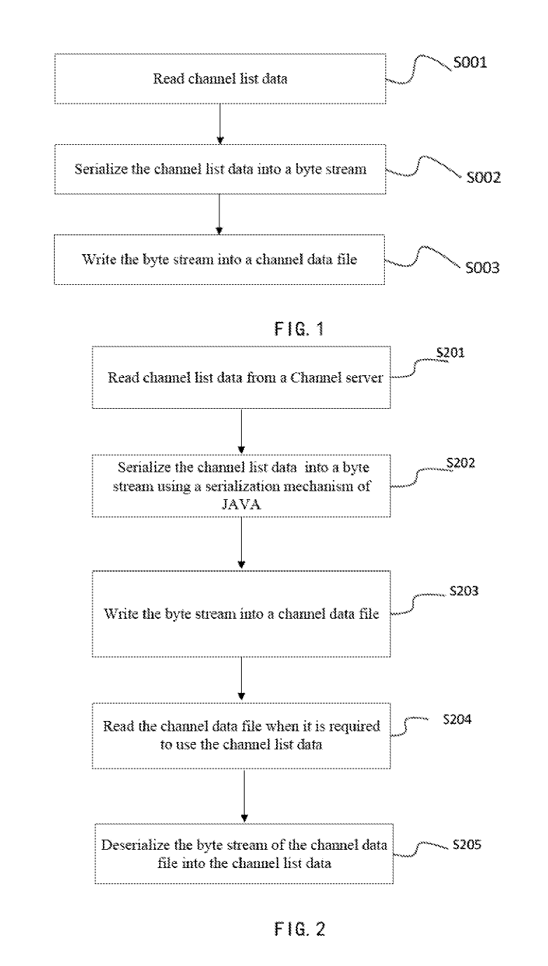

Referring to FIG. 1, an embodiment of the present disclosure provides a method for storing channel data, including: step S001, reading channel list data; step S002, serializing the channel list data into a byte stream; and step S003, writing the byte stream into the channel data file. In step S001, the channel list data will be stored in a channel list server or stored locally. In step S002, for serializing the channel list data into a sequence in the byte stream it is a process of converting the state information of an object into a form that can be stored or transmitted. During the serialization period, the object writes the current state thereof into a temporary or persistent storage area. Afterwards, the object may be newly created through reading and deserializing the state of the object from the storage area. Usually, all the fields of an object example will be serialized, which means that data will be represented as the serialized data of the object example. Similarly, data is extracted from a serialized representation form through deserializing, and the object state is set directly. Finally in step S003, the serialized byte stream is written into the channel data file for deserializing.

The channel data is stored more conveniently through a manner of serializing the channel list data into the byte stream and storing the byte stream into the channel data file, and the memory and storage time are saved in the meanwhile.

In one embodiment of the present disclosure, the channel list data includes basic channel information and a channel video stream, and the basic channel information includes a channel number and a channel name. For example, the channel number and the channel name may be as follows: 1 education zone, wherein 1 represents the channel number, and the education zone represents the channel name. The channel video stream is a video to be played in the channel, for instance, an educational cartoon video of a video stream corresponding to the education zone numbered as 1.

In one embodiment of the present disclosure, the channel list data is read from a server storing the channel list data or the channel list data is read locally. In general, the channel list data is stored in a channel server, and the channel list data is read from the channel server.

In one embodiment of the present disclosure, the byte stream of the channel data file is read in response to a channel data file reading instruction, and the byte stream is deserialized such that the channel list data is obtained. When it is required to use the channel list data, for example, at this time a user needs to know the program list of a channel having a channel number of 1, the byte stream needs to be read from the channel data file firstly, and the byte stream is deserialized, then the channel list data stored as the byte stream is restored into an channel object, and the channel name and the channel video stream information are displayed to the user according to the channel number.

By storing and reading the channel list data through a manner of deserializing the serialized byte stream of the channel data file into the channel list data, the memory is saved when storing the channel list data, and the channel list data is read more quickly in the meanwhile.

In one embodiment of the present disclosure, the channel list data is serialized into the byte stream using a serialization mechanism provided by a JAVA programming language. Using the serialization mechanism provided by a JAVA program to serialize and deserialize the channel data enables a program to be written more conveniently, and avoid error during storing and reading the channel data.

For example, the channel list data may be serialized using following program statements:

```
    public static void write(String filePath, Object obj) {
    ActivityLog aLog = new ActivityLog(“write(“ + filePath + ”)”);
    try {
        ObjectOutputStream oos = new ObjectOutputStream(new
FileOutputStream(filePath));
        oos.writeObject(obj);
        oos.close( );
    } catch (IOException e) {
        e.printStackTrace( );
    }
    JLog.d(TAG, aLog.toString( ));
}
```

For example, the channel list data may be deserialized using the following program statements:

```
    public static Object read(String filePath) {
    File file = new File(filePath);
    if (file.exists( )) {
        ObjectInputStream ois;
        try {
            ois =
            new ObjectInputStream(new FileInputStream(filePath));
            Object obj = ois.readObject( );
            ois.close( );
            return obj;
        } catch (IOException e) {
            e.printStackTrace( );
        } catch (ClassNotFoundException e) {
            e.printStackTrace( );
        }
    }
    return null;
}
```

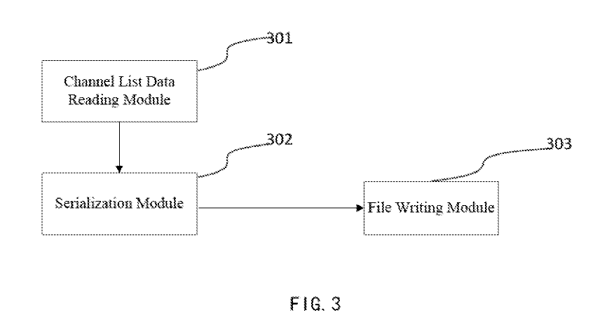

Referring to FIG. 2, as an embodiment of the present disclosure, channel list data is stored through a manner of serializing the channel list data into a byte stream and storing the byte stream in a channel data file and deserializing the byte stream into the channel list data when reading the channel data file. In step S201, channel list data is read from a channel server; in step S202, the channel list data is serialized into a byte stream by using a serialization mechanism of JAVA; in step S203, the byte stream is written into a channel data file; in step S204, the channel data file is read when it is required to use the channel list data; and in step 205, the byte stream of the channel data file is deserialized into the channel list data.

By serializing the channel list data into the byte stream and deserializing the byte stream of the channel data file into the channel list data, the memory is saved when storing the channel list data, and the channel list data is read more quickly in the meanwhile.

Referring to FIG. 3, one embodiment of the present disclosure provides a device for storing channel data, including: a channel list data reading module 301 configured to read channel list data; a serialization module 302 configured to serialize the channel list data into a byte stream; and a file writing module 303 configured to write the byte stream into a channel data file. For serializing the channel list data into a sequence in the byte stream by the serialization module 302 it is a process of converting the state information of an object into a form that can be stored or transmitted. During the serialization period, the object writes the current state thereof into a temporary or persistent storage area. Afterwards, the object may be newly created through reading or deserializing the state of the object from the storage area. Usually, all the fields of an object example will be serialized, which means that data will be represented as the serialized data of the object example. Similarly, data is extracted from a serialized representation form through deserializing, and the object state is set directly. The serialized byte stream is written into the channel data file by the file writing module 303 for deserializing.

The channel data is stored more conveniently through a manner of serializing the channel list data into the byte stream and storing the byte stream into the channel data file, and the memory and storage time are saved in the meanwhile.

In one embodiment of the present disclosure, the channel list data includes basic channel information and a channel video stream, and the basic channel information includes a channel number and a channel name.

In one embodiment of the present disclosure, the channel list data is read from a server storing the channel list data or the channel list data is read locally.

In one embodiment of the present disclosure, the byte stream of the channel data file is read in response to a channel data file reading instruction, and the byte stream is deserialized such that the channel list data is obtained.

In one embodiment of the present disclosure, the channel list data is serialized into the byte stream using a serialization mechanism provided by a JAVA programming language.

In one embodiment of the present disclosure, the channel list data is serialized into the byte stream using a serialization mechanism provided by a JAVA programming language. Using the serialization mechanism provided by a JAVA program to serialize and deserialize the channel data enables a program to be written more conveniently, and avoid error during storing and reading the channel data.

It may be understood by those skilled in the art that the all or part flows of implementing the methods in the foregoing embodiments may be finished through relevant hardware instructed by a computer program. The program may be stored in a mobile device or a computer readable storage medium, and the program while performing includes one or a combination of the flows of the embodiments according to the methods above. Based on such understanding, the foregoing technical solutions essentially, or the part contributing to the prior art, or the part of the technical solution may be implemented in the form of a software product. The computer software product may be stored in a storage medium, and includes several instructions for instructing a mobile terminal (which may be a personal computer, a server, or a network device, a mobile phone so on) to execute the all or a part of steps of the method according to each embodiment of the present disclosure. While the fore mentioned storage medium includes: any medium that is capable of storing program codes, such as a USB disk, a mobile hard disk drive, a read-only memory (ROM, Read-Only Memory), a random access memory (RAM, Random Access Memory), a magnetic disk, or an optical disk.

The above embodiments are for purposes of illustration and description to the technical solution of the present disclosure merely, but are not intended to limit the present disclosure. Although the embodiments of the present disclosure has been illustrated in detail according to the foregoing embodiments, those skilled in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the claims.

What is claimed is:

1. A device for storing channel data, comprising:
at least one processor; and
a memory communicably connected with the at least one processor and for storing instructions executable by the at least one processor,
wherein execution of the instructions by the at least one processor causes the at least one processor to:
read channel list data;
serialize the channel list data into a byte stream; and
write the byte stream into a channel data file.

2. The device for storing channel data according to claim 1, wherein the channel list data comprises basic channel information and a channel video stream, and the basic channel information comprises a channel number and a channel name.

3. The device for storing channel data according to claim 1, wherein the channel list data is read from a server storing the channel list data, or the channel list data is read locally.

4. The device for storing channel data according to claim 1, wherein the byte stream of the channel data file is read in response to a channel data file reading instruction, and the byte stream is deserialized such that the channel list data is obtained.

5. The device for storing channel data according to claim 1, wherein the channel list data is serialized into the byte stream using a serialization mechanism provided by a JAVA programming language.

6. A method for storing channel data, comprising:
at an electronic device:
reading channel list data;
serializing the channel list data into a byte stream; and
writing the byte stream into a channel data file.

7. The method for storing channel data according to claim 6, wherein the channel list data comprises basic channel information and a channel video stream, and the basic channel information comprises a channel number and a channel name.

8. The method for storing channel data according to claim 6, wherein the channel list data is read from a server storing the channel list data, or the channel list data is read locally.

9. The method for storing channel data according to claim 6, wherein the byte stream of the channel data file is read in response to a channel data file reading instruction, and the byte stream is deserialized such that the channel list data is obtained.

10. The method for storing channel data according to claim 6, wherein the channel list data is serialized into the byte stream using a serialization mechanism provided by a JAVA programming language.

11. A non-transitory computer-readable storage medium storing executable instructions that, when executed by an device, cause the device to:
read channel list data;
serialize the channel list data into a byte stream; and
write the byte stream into a channel data file.

12. The non-transitory computer-readable storage medium according to claim 11, wherein the channel list data comprises basic channel information and a channel video stream, and the basic channel information comprises a channel number and a channel name.

13. The non-transitory computer-readable storage medium according to claim 11, wherein the channel list data is read from a server storing the channel list data, or the channel list data is read locally.

14. The non-transitory computer-readable storage medium according to claim 11, wherein the byte stream of the channel data file is read in response to a channel data file reading instruction, and the byte stream is deserialized such that the channel list data is obtained.

15. The non-transitory computer-readable storage medium according to claim 11, wherein the channel list data is serialized into the byte stream using a serialization mechanism provided by a JAVA programming language.
